(19) United States
(12) Patent Application Publication
(10) Pub. No.: US 2009/0182456 A1
(43) Pub. Date: Jul. 16, 2009

(54) PROGRAMMING CONTROL SYSTEM FOR ADJUSTING AN AIR CONDITIONING EQUIPMENT

(75) Inventors: Shiue-Juan Liao, Taipei (TW); Shu-Fen Lin, Taipei (TW); Chun-Hung Huang, Taipei (TW); Yu-Huan Wang, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: CHUNGHWA TELECOM CO., LTD., Taipei (TW)

(21) Appl. No.: 12/339,012

(22) Filed: Dec. 18, 2008

(30) Foreign Application Priority Data
Jan. 15, 2008 (TW) 097101441

(51) Int. Cl. G05B 15/00

(52) U.S. Cl. 700/276

(57) ABSTRACT

A programming control system for adjusting an air conditioning equipment is provided, which include an air conditioning control unit for being activated according to a preset time period, the air conditioning control unit to execute adjustment of the air conditioning equipment based on corresponding preset control parameters; accordingly, the programming control system for adjusting an air conditioning equipment is capable of adjusting the air conditioning equipments to a preferable usage state, thereby achieving objective of providing a conformable temperature as well as saving energy consumption.

### BACKGROUND OF THE INVENTION

1. Field of the Invention

This invention generally relates to control systems for an air conditioning equipment, and more specifically, to a programming control system for adjusting an air conditioning equipment, which integrates with programming control mechanism.

2. Description of Related Art

Air conditioning equipments are electronic equipments widely applied to and installed in various buildings, especially in large-scale commercial places, such as office buildings, factory buildings, hotels, restaurants, hospitals, supermarkets, wholesale stores, and department stores. Presently, an air conditioning equipment normally includes at least an air conditioner heater unit, air handling unit (AHU), precooling air handler (PAH), and fan coil unit (FCU). Such an air conditioning equipment is basically capable of adjusting air temperature inside an enclosed space to a desired condition for people to stay in, and by taking in outdoor fresh air it can avoid discomfort and danger caused by over-high level of carbon dioxide inside the enclosed space.

The conventional air conditioning equipment generally operates for long hours or even 24 hours a day, and the energy consumed by the air conditioning equipment depends on a variety of factors, including environmental factors such as usage space, temperature, humidity, direct sunlight effect, crowdedness as well as usage habit.

In conventional operation and management, the air conditioning equipment in operation has to be monitored by workers. For instance, such environmental factors as indoor temperature, humidity, carbon dioxide level have to be monitored if they do not go beyond the preset limits anytime, or else the air conditioning equipment needs to be adjusted to maintain those environmental factors within the limits. In order to save workers labor of regular or irregular checkups and adjustments of the air conditioning equipments, control terminals of Environmental Values are installed at specific locations of various places in the prior art. For instance, a sensor unit can be installed in a corner of a conference room Environmental Values for detecting Environmental Values such as indoor temperature/humidity, and/or carbon dioxide level and a control unit can be additionally installed for allowing users to adjust the Environmental Values Environmental Values of the conference room Environmental Values based on different needs by the control unit.

One of the disadvantages in the prior art is exemplified below. Since users are allowed to change the settings of Environmental Values out of personal senses, habits, or favors freely, the overall condition of a high energy consumption may happen. For instance, if a user is just entering the conference room from the outdoors at an excessively high temperature, he may adjust the preset room temperature of 28° to 20° for a personal desire. However, the air conditioning equipment will be led to a high energy consumption status only to satisfy one user's need; meanwhile the other users already used to the preset room temperature of 28° may feel uncomfortable with the sudden drop in temperature.

On the contrary, even though a user's personal setting conforms to a standard of energy saving or a higher standard such as a room temperature of 30°, it may cause the other users' discomfort.

In addition, indoor and outdoor temperature may change upon different hours of a day, or seasons. For instance, the outdoor temperature at noon in July and August may reach 35°, and a 29° indoor room temperature is cool enough to make both the users already inside and the users newly entering feel comfortable. While the outdoor temperature is lower than the indoor temperature, introducing the outdoor air via air conditioning equipments such as fan coil units is adequate to achieve the purpose of regulating temperature and the indoor carbon dioxide level at the same time. However, there is no solution to provide a programming control system for adjusting air conditioning equipments in the prior art time periods to give consideration to both comfort and energy saving in response to the difference in Environmental Values between the indoors and outdoors.

Hence, it is highly desired for the industry to provide a technique capable of preventing users from adjusting air conditioning equipments out of personal favors or habits freely; at the same time allowing the indoor Environmental Values to be adjusted Environmental Values to a state of comfort and energy saving through a programming control system in response to the difference in Environmental Values between the indoors and outdoors.

### SUMMARY OF THE INVENTION

In view of the disadvantages of the prior art mentioned above, the present invention is to provide a programming control system for adjusting an air conditioning equipment, which is capable of adjusting and controlling the air conditioning equipment by establishing a program for monitoring indoor and outdoor Environmental Values based on corresponding preset control parameters regularly or irregularly.

The programming control system for adjusting an for adjusting an air conditioning equipment according to the present invention is also capable of monitoring indoor and outdoor Environmental Values according to set programming information so as to adjust and control the air conditioning equipment during various time periods corresponding to the preset control parameters.

The programming control system for adjusting an air conditioning equipment of the present invention comprises: a database, the a setting module for setting the programming information, preset indoor Environmental Values, and the preset control parameters corresponding to the preset indoor Environmental Values, and for transmitting the information, preset indoor Environmental Values, and present control parameters set by the setting module to the database for saving; a monitoring unit for monitoring outdoor Environmental Values and/or indoor Environmental Values, and for the monitored outdoor Environmental Values and/or the indoor Environmental Values obtained from the database; and an air conditioning control device for adjusting and controlling the air conditioning equipment the according to the programming information, the outdoor Environmental Values, the indoor Environmental Values, the preset indoor Environmental Values, and/or the preset control parameters corresponding to the preset indoor Environmental Values.

In one embodiment of the present invention, the database, the setting module, the monitoring unit, and/or the air conditioning control device are connected to a data processing device, which is configured for network connection and data transmission. The data processing device is capable of being connected to a remote end air conditioning equipment via a network communication system so as to adjust and control the remote end air conditioning equipment via the network communication system.

In another embodiment of the present invention, the programming control system further comprises a time counting module for receiving the programming information, preset indoor Environmental Values, and preset control parameters set by the setting module and for executing time count so as to provide the air conditioning control device with time obtained from the execution of time count to thereby enable the air conditioning control device to adjust and control the air conditioning equipment according to the time, the programming information, the outdoor Environmental Values, the indoor Environmental Values, the preset indoor Environmental Values, and/or the preset control parameters corresponding to the preset indoor Environmental Values. The time obtained from the execution of time count can be selectively divided into various time periods, and each of the time periods has its own corresponding preset indoor Environmental Values; and the corresponding preset indoor Environmental Values of the time periods may be different from on another. Further, the time counting module can be connected to the data processing device.

In another embodiment of the present invention, the programming control system may further comprises a date counting module for receiving the programming information, preset indoor Environmental Values, and preset control parameters set by the setting module and for executing date count so as to provide the air conditioning control device with date obtained from the execution of date count to thereby enable the air conditioning control device to adjust and control the air conditioning equipment based on the date, time, programming information, outdoor Environmental Values, indoor Environmental Values, the preset indoor Environmental Values, and/or preset control parameters corresponding to the preset indoor Environmental Values. Further, the date obtained from the date counting can be selectively divided into various date blocks, and each of the date blocks has its own corresponding preset indoor Environmental Values. And the preset indoor Environmental Values corresponding to the date blocks can be different from one another. Further, the date counting module can be connected to the data processing device.

### BRIEF DESCRIPTION OF DRAWINGS

The present invention can be more fully understood by reading the following detailed description of the preferred embodiments, with reference made to the accompanying drawings, wherein:

FIG. 1 is a block diagram of a first embodiment of the programming control system for adjusting an air conditioning equipment of the present invention;

FIG. 2 is a block diagram of a second embodiment of the programming control system for adjusting an air conditioning equipment of the present invention; and

FIG. 3 is a block diagram of a third embodiment of the programming control system for adjusting an air conditioning equipment of the present invention.

### DETAILED DESCRIPTION OF PREFERRED EMBODIMENTS

The following illustrative embodiments are provided to illustrate the disclosure of the present invention, and these and other advantages and effects can be apparently understood by those skilled in the art after reading the disclosure of this specification. The present invention can also be performed or applied by other different embodiments. The details of the specification may be on the basis of different points and applications, and numerous modifications and variations can be devised without departing from the spirit of the present invention.

### First Embodiment

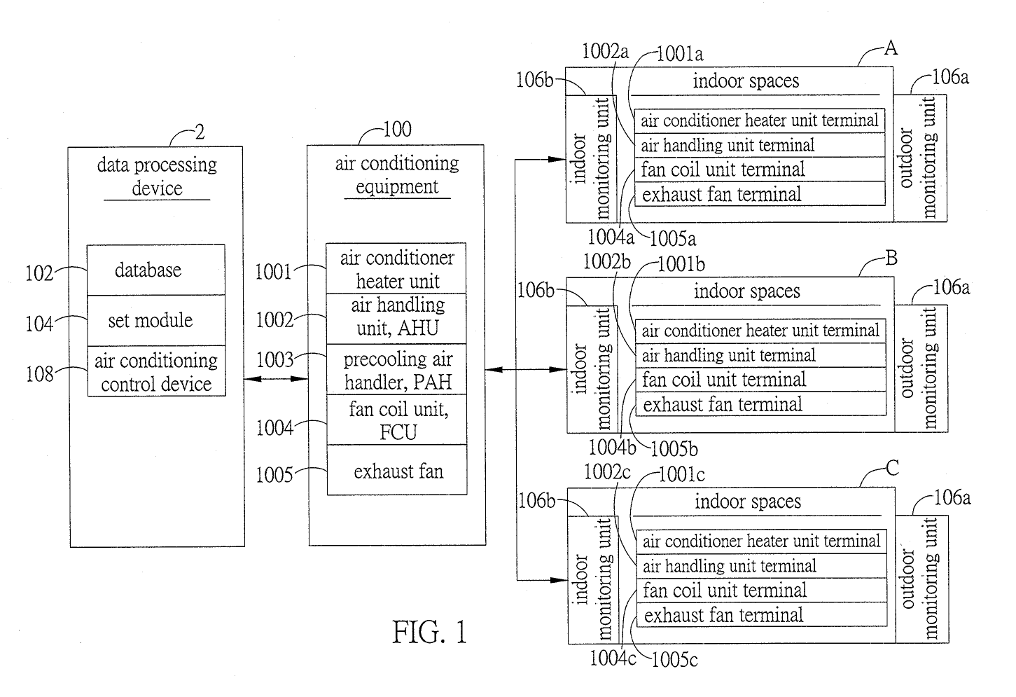

Referring to FIG. 1, a block diagram of the first embodiment of the programming control system for adjusting an air conditioning equipment of the present invention is illustrated. According to the first embodiment, the programming control system for adjusting an air conditioning equipment of the present invention is applicable to any air conditioning equipment 100 installed inside various buildings, especially large-scaled commercial places, such as office buildings, factory buildings, hotels, restaurants, hospitals, supermarkets, wholesale stores, department stores, for purpose of adjustment and control of the air conditioning equipment 100; the air conditioning equipment 100 is typically consisted of an air conditioner heater unit 1001, air handling unit (AHU) 1002, precooling air handler (PAH) 1003, fan coil unit (FCU) 1004, and exhaust fan 1005. The air conditioner heater unit 1001 is for adjusting temperature of the operation surroundings; the air handling unit 1002 is for adjusting humidity of indoor surroundings; the fan coil unit 1004 is connected to air conditioner heater unit 1001 and/or air handling unit 1002, for sending out air with adjusted temperature by the air conditioner heater unit 1001 and/or adjusted humidity by the air handling unit 1002; the exhaust fan 1005 is for exhausting unclean air from the operation surroundings of the air conditioner heater unit 1001 and the air handling unit 1002, to thereby adjust airborne micro particle level, carbon monoxide level and/or carbon dioxide level inside the operation surroundings; the precooling air handler 1003 is for bringing in external fresh air to the indoor operation surroundings, to thereby adjust airborne micro particle level, carbon monoxide level and/or carbon dioxide level inside the operation surroundings, and to also adjust temperature of brought-in external fresh air, such that temperature of the operation surroundings can be prevented from dramatic change caused by the brought-in external fresh air.

It must be specifically stated that, the air conditioning equipment 100 is not restricted to the aforesaid combination of the air conditioner heater unit 1001, air handling unit (AHU) 1002, precooling air handler (PAH) 1003, fan coil unit (FCU) 1004, and exhaust fan 1005. The combination of components for the air conditioning equipment 100 can be optionally varied, depending upon practical requirements. In the first embodiment, the indoor operation surroundings are divided into spaces A, B, and C. And the air conditioner heater unit 1001, air handling unit 1002, fan coil unit 1004, and exhaust fan 1005 have air conditioner heater unit terminals 1001a and 1001b and 1001c, air handling unit terminals 1002a and 1002b and 1002c, fan coil unit terminals 1004a and 1004b and 1004c, and exhaust fans terminals 1005a and 1005b and 1005c allocated into indoor spaces A, B, and C respectively. Accordingly, the conditioner heater unit terminals 1001a and 1001b and 1001c and the air handling unit terminals 1002a and 1002b and 1002c are used for adjusting temperature and humidity of the spaces A, B, and C respectively, while the fan coil unit terminals 1004a and 1004b and 1004c and the exhaust fan terminals 1005a and 1005b and 1005c are used for adjusting airborne micro particle level and carbon monoxide level and/or carbon dioxide level inside the spaces A, B, and C respectively. It is to be understood that numbers of divided space of the operation surroundings, air conditioner heater unit terminal, air handling unit terminal, fan coil unit terminal, and exhaust fan terminal are variable according to practical application requirement.

The programming control system for adjusting an air conditioning equipment of the present invention is comprised of a database 102, a setting module 104, a monitoring unit 106, and an air conditioning control device 108. In the present embodiment, the database 102, the setting module 104, the monitoring unit 106 having an indoor monitoring module 106a and an outdoor module unit 106b, and/or air conditioning control device 108 are connected to a data processing device 2.

The database 102 is for saving data including programming information, outdoor Environmental Values, indoor Environmental Values, preset indoor Environmental Values, and preset control parameters corresponding to the preset indoor Environmental Values. The outdoor Environmental Values and the indoor Environmental Values can be separately selected from the group consisting of temperature, humidity, airborne micro particle level, carbon monoxide level, and carbon dioxide level; such preset indoor Environmental Values are subject to preset numeric values of temperature, humidity, airborne micro particle level, carbon monoxide level, and/or carbon dioxide level. For instance, ideal temperature of an indoor surrounding can be preset at 28° or 5° below outdoor temperature, ideal humidity of the indoor surroundings can be preset with a range of 40% to 50%, ideal airborne micro particle level of the indoor operation surroundings can be preset to 0.15 mg/m³ or below, ideal carbon monoxide level of the indoor operation surroundings can be preset to 9 ppm or below, and ideal carbon dioxide level of the indoor operation surroundings can be preset to 600 ppm or below. The preset control parameters corresponding to the preset indoor Environmental Values are parameters for the control of the operations of the air conditioner heater unit terminals, air handling unit terminals, fan coil unit terminals, exhaust fan terminals, and precooling air handler. Namely, with the input of the preset control parameters, the air conditioning control device 108 is able to adjust current indoor Environmental Values to the preset indoor Environmental Values. Accordingly, these parameters are used for determining activation time, operation time, operation level, and so on, of the air conditioning equipment, so as to adjust the indoor Environmental Values close to or equal to the preset indoor Environmental Values.

The setting module 104 is for setting programming information, preset indoor Environmental Values, and preset control parameters corresponding to the preset indoor Environmental Values. The setting module 104 is also capable of transmitting the programming information, preset indoor Environmental Values, and preset control parameters set by the setting module 104 to the database 102 for saving.

The monitoring unit 106 for monitoring the outdoor Environmental Values and/or the indoor Environmental Values based on the programming information, and for transmitting the outdoor Environmental Values and/or the indoor Environmental Values obtained from the monitoring process to the database 102 for saving. In the present embodiment, the monitoring unit 106 further comprises an outdoor monitoring module 106a for monitoring the outdoor Environmental Values, and an indoor monitoring module 106b for monitoring the indoor Environmental Values.

The air conditioning control device 108 is for, based on the data saved in the database, which include the programming information, outdoor Environmental Values, indoor Environmental Values, preset indoor Environmental Values and/or control parameters corresponding to the preset indoor Environmental Values, executing process of adjustment and control of the air conditioner heater unit terminals 1001a and 1001b and 1001c, the air handling unit terminals 1002a and 1002b and 1002c, the precooling air handler 1003, the fan coil unit terminals 1004a and 1004b and 1004c, and the exhaust fan terminals 1005a and 1005b and 1005c.

For example, when the outdoor monitoring module 106a detects outdoor temperature of 32°, relative humidity of 80%, airborne micro particle level of 0.15 mg/m³ or below, carbon monoxide level of 9 ppm or below, and carbon dioxide level of 600 ppm or below, while the indoor monitoring module 106b detects in space A temperature of 30°, relative humidity of 75%, airborne micro particle level of 0.15 mg/m³, carbon monoxide level below 9 ppm, and carbon dioxide level below 600 ppm. Further, the setting module 104 has already preset indoor Environmental Values and also saved these values in the database 102, for instance, ideal temperature of the indoor operation surroundings is preset at 28°, ideal humidity of the indoor operation surroundings is preset to a relative humidity of 60%, ideal airborne micro particle level of the indoor operation surroundings is preset below 0.15 mg/m³, ideal carbon monoxide level of the indoor operation surroundings is preset below 9 ppm, and ideal carbon dioxide level of indoor the operation surroundings is preset below 600 ppm; and the programming information saved in the database 102 includes aforementioned various preset ideal values of the indoor operation surroundings, to which indoor Environmental Values of the space A are to be adjusted.

The air conditioning control device 108 will, according to the preset control parameters corresponding to the preset indoor Environmental Values, activate the air conditioner heater unit terminal 1001a, the air handling unit terminal 1002a, and the fan coil unit terminal 1004a to bring down temperature by 2° and relative humidity by 15% inside the space A.

Likewise, if the indoor monitoring module 106b detects that airborne micro particle level of the space A is above 0.15 mg/m³, carbon monoxide level is above 9 ppm, and carbon dioxide level is above 600 ppm, the air conditioning control device 108 will activate the air conditioner heater unit terminal 1001a, the air handling unit terminal 1002a, the precooling air handler 1003, the fan coil unit terminal 1004a, and the exhaust fan terminal 1005a to reduce the airborne micro particle level of the space A to 0.15 mg/m³ or below, carbon monoxide level to 9 ppm or below, carbon dioxide level to 600 ppm or below.

### Second Embodiment

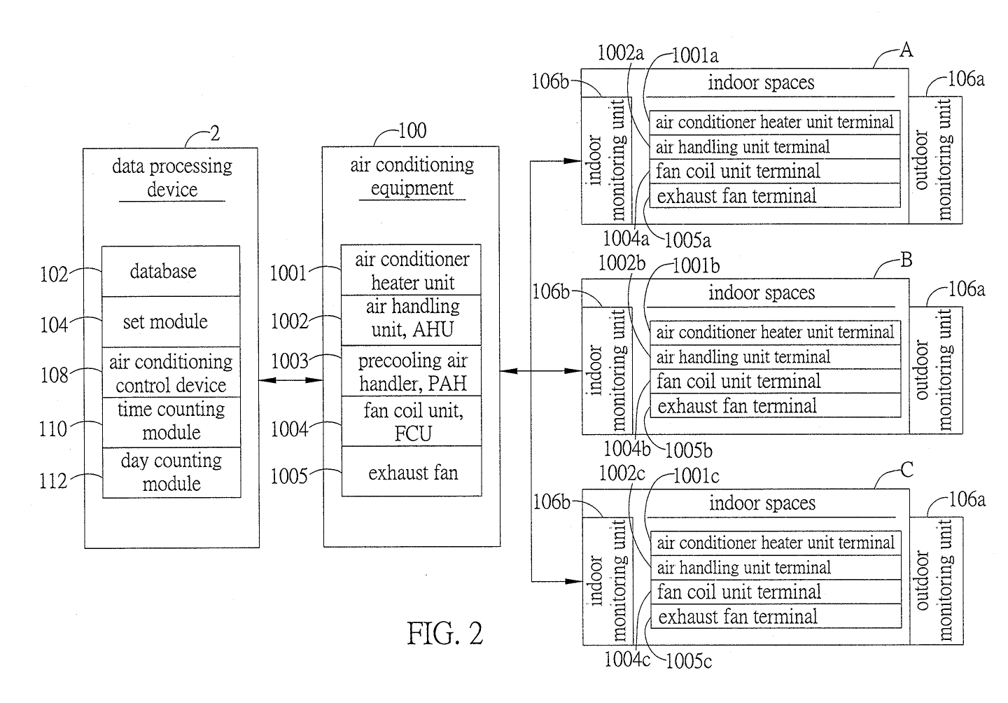

FIG. 2 shows a block diagram of the second embodiment of the programming control system for adjusting an air conditioning equipment of the present invention. In the second embodiment, the air conditioning equipment 100 is the same as that in the first embodiment, and the structure of the programming control system in the second embodiment is also the same as that in the first embodiment.

The main difference between the first and the second embodiments is that the programming control system for adjusting an air conditioning equipment in the second embodiment further comprises a time counting module 110 and a date counting module 112.

The time counting module 110 is for receiving the programming information, preset indoor Environmental Values, and preset control parameters set by a setting module 104 and for allowing an air conditioning control device 108 to execute time count so as to provide the air conditioning control device 108 with time obtained from the execution of time count to thereby enable the air conditioning control device 108 to adjust and control the air conditioning equipment 100 according to the time, the programming information, the outdoor Environmental Values, the indoor Environmental Values, the preset indoor Environmental Values, and/or the preset control parameters corresponding to the preset indoor Environmental Values. The time obtained from the execution of time count can be selectively divided into various time periods, and each of the time periods has its own corresponding preset indoor Environmental Values; and the corresponding preset indoor Environmental Values of the time periods may be different from on another. Further, the time counting module 110 can be connected to a data processing device 2.

For example, the first time period is preset from 8 a.m. to 11 a.m., the second time period is preset from 11 a.m. to 2 p.m., the third time period is preset from 2 p.m. to 5 p.m., and so forth. The indoor Environmental Value of the first time period is 28 degrees, namely the ideal temperature is preset at 28°. The indoor Environmental Value of the second time period is 29 degrees, namely the ideal temperature is preset at 29°. And the indoor Environmental Value of the third time period is 28 degrees, namely the ideal temperature is preset at 28°. Accordingly, the air conditioning control device 108 will execute adjustment of the air conditioning equipment 100 at various time periods based on the programming information, outdoor Environmental Values, indoor Environmental Values, preset indoor Environmental Values and/or the control parameters corresponding to the preset indoor Environmental Values saved in the database 102, thereby enable indoor temperature inside space A to equal to the preset requirements at each time period. The frequency to execute the monitoring of indoor and outdoor Environmental Values and the adjustment of the air conditioning equipment 100 can be set to, but not limited to, once an hour.

A date counting module 112 is for receiving the programming information, preset indoor Environmental Values, and preset control parameters set by a setting module 104 and for allowing an air conditioning control device 108 to execute date count so as to provide the air conditioning control device 108 with date obtained from the execution of time count to thereby enable the air conditioning control device 108 to adjust and control the air conditioning equipment 100 according to the date, the programming information, the outdoor Environmental Values, the indoor Environmental Values, the preset indoor Environmental Values, and/or the preset control parameters corresponding to the preset indoor Environmental Values. Further, the date obtained from the date counting can be selectively divided into various date blocks, and each of the date blocks has its own corresponding preset indoor Environmental Values. And the preset indoor Environmental Values corresponding to the date blocks can be different from one another. Further, the date counting module 112 can be connected to the data processing device 2.

For instance, the first date period is preset from January through March, the second date period is preset from April through June, the third date period is preset from July through September, and the fourth date period is preset from October through December. The indoor Environmental Value of the first date period is 27 degrees, namely the ideal temperature is 27°. The indoor Environmental Value of the second date period is 27.5 degrees, namely the ideal temperature is 27.5°. The indoor Environmental Value of the third date period is 28°, namely the ideal temperature is 28°. And the indoor Environmental Value of the fourth date period is 27°, namely ideal temperature is 27°. Accordingly, the air conditioning control device 108 will execute adjustment of the air conditioning equipment 100 at various date periods based on the programming information, outdoor Environmental Values, indoor Environmental Values, preset indoor Environmental Values and/or the control parameters corresponding to the preset indoor Environmental Values saved in the database 102, thereby enable indoor temperature inside space A to equal to the preset requirements at each date period.

In another embodiment, the present invention is capable of presetting dates on national holidays or typhoon holidays, and presetting the corresponding programming information of the dates so as to allow adjustment of the air conditioning equipment 100, for example, automatic shutdowns on one or all sets of the air conditioning equipments on specific dates, and/or operations on one of the air conditioning equipments in space A, B, or C. Accordingly, the date counting module 112 is capable of executing date count, and providing the air conditioning control device 108 with date obtained from the execution of date count to thereby enable the air conditioning control device to adjust and control the air conditioning equipment based on the date, time, programming information of holidays, outdoor Environmental Values, indoor Environmental Values, the preset indoor Environmental Values, and/or preset control parameters corresponding to the preset indoor Environmental Values. Further, by the adjustment of the air conditioning equipment 100, one or all of the air conditioning equipments can be turned off and/or only one of the air conditioning equipments 100 in space A, B, or, C will be turned on.

It is to be noted that the time counting module 110 and the date counting module 112 can optionally be installed collectively or separately. In the second embodiment, the programming control system for adjusting an air conditioning equipment comprises a time counting module 110 and a date counting module 112 concurrently. Therefore, there will be a set of corresponding preset indoor Environmental Value and preset control parameter at each time period of a different date block.

### Third Embodiment

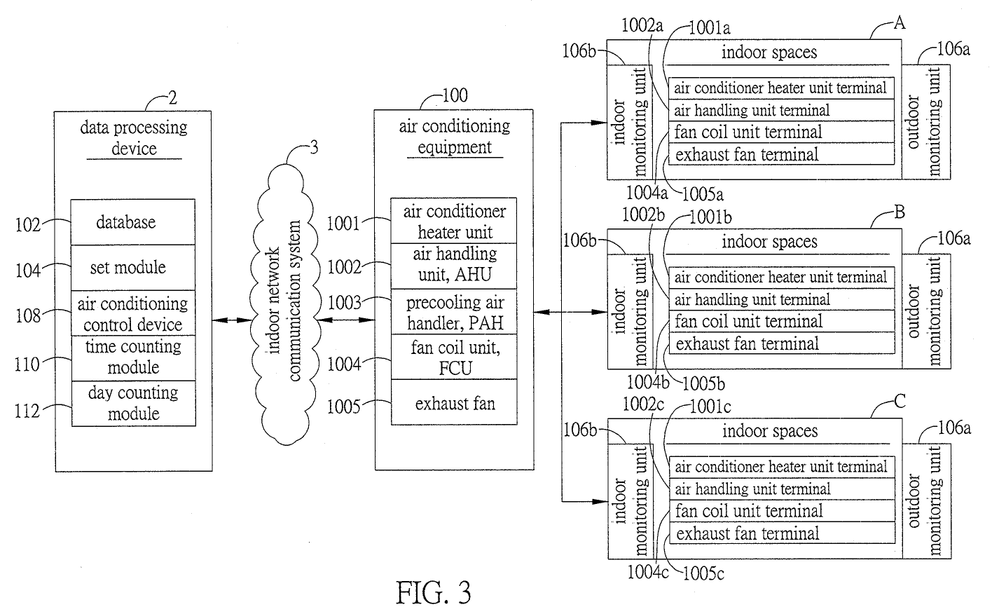

Referring to FIG. 3, a block diagram of the first embodiment of the programming control system for adjusting an air conditioning equipment of the present invention is illustrated. The air conditioning equipment 100 of the third embodiment is the same as that in the first and the second embodiments, and the structure of the programming control system for adjusting an air conditioning equipment in the third embodiment is also the same as that in the second embodiment.

In the third embodiment, a database 102, a setting module 104, a air conditioning control device 108, a time counting module 110, a date counting module 112 are connected to a data processing device 2, which is configured for network connection and data transmission. And a outdoor monitoring module 106a and an indoor monitoring module 106b are capable of being connected to a remote end air conditioning equipment 100 via a network communication system 3 so as to adjust and control the remote end air conditioning equipment 100 via the network communication system 3.

More specifically, in the third embodiment, the database 102, the setting module 104, the air conditioning control device 108, the time counting module 110, and the date counting module 112 are connected to a remote end data processing device 2, while the outdoor monitoring module 106a and the indoor monitoring module 106b are allocated inside spaces A, B, and C. All parts are connected via the network communication system 3 and the database 102, the setting module 104, the time counting module 110, and the date counting module 112 to operate together. In other words, the setting module 104 and the air conditioning control device 108 of the remote end data processing device 2 are capable of receiving outdoor and indoor Environmental Values detected by the local outdoor monitoring module 106a and the indoor monitoring module 106b via the network communication system 3 to allow a remote control of the local air conditioning equipment 100.

In addition, the present embodiment can be integrated with the first embodiment, wherein the database 102, the setting module 104, and the air conditioning control device 108 are connected to the remote end data processing device 2, while the monitoring units 106 are allocated locally inside space A, B, and C.

### Fourth Embodiment

The forth embodiment is applicable to the first, the second and the third embodiments. More specifically, the setting module 104 is used for presetting and saving indoor Environmental Values of the database 102, namely, the ideal temperature is preset to 5° below the outdoor temperature. In other words, no matter what the outdoor temperature is, the indoor temperature is always 5° lower the outdoor temperature. For instance, if the outdoor temperature is 34°, the indoor temperature should be adjusted to 29°, and if the outdoor temperature is 35°, the indoor temperature should be adjusted to 30°. By presetting an ideal temperature difference, it can prevent the air conditioning equipment 100 from high loading operation for a long time in order to reach a specific temperature as the outdoor temperature is high, and thereby consume overly high energy, e.g. enforcing to reduce the indoor temperature to 28° as the outdoor temperature is 35°.

In view of the above, the programming control system for adjusting an air conditioning equipment of the present invention is characterized by monitoring outdoor and indoor Environmental Values, enabling an air conditioning control device to adjust and control the air conditioning equipment according to corresponding preset control parameters and programming information. In addition, it may further comprise a time counting module and/or a date counting module to adjust the air conditioning equipment to a comfort state at various time periods and/or date blocks according to the corresponding preset indoor Environmental Values and/or control parameters corresponding to the preset indoor Environmental Values, thereby achieve the objectives of temperature adjustment and energy saving of the air conditioning equipment.

The foregoing descriptions of the detailed embodiments are only illustrated to disclose the features and functions of the present invention and not restrictive of the scope of the present invention. It should be understood to those skilled in the art that all modifications and variations according to the spirit and principle in the disclosure of the present invention should fall within the scope of the appended claims.

What is claimed is:

1. A programming control system for adjusting an air conditioning equipment, comprising:
a database a setting module for setting programming information, preset indoor Environmental Values, and preset control parameters corresponding to the preset indoor Environmental Values, and for transmitting the programming information, preset indoor Environmental Values, and preset control parameters set by the setting module to the database for saving;
a monitoring unit for monitoring outdoor Environmental Values and/or the indoor Environmental Values based on the programming information, and for transmitting the monitored outdoor Environmental Values and/or the indoor Environmental Values to the database for saving; and
an air conditioning control device for executing adjustment of the air conditioning equipment according to the set programming information, outdoor Environmental Values, indoor Environmental Values, preset indoor Environmental Values and/or preset control parameters.

2. The programming control system for adjusting an air conditioning equipment of claim 1, wherein the database, the setting module, the monitoring module and/or the air conditioning control device are connected to a data processing device.

3. The programming control system for adjusting an air conditioning equipment of claim 2, wherein the data processing device is configured for network connection and data transmission, and is capable of connecting with a remote end air conditioning equipment via a network communication system so as to execute adjustment and control of the remote end air conditioning equipment via the network communication system.

4. The programming control system for adjusting an air conditioning equipment of claim 1, wherein a monitoring unit comprises an outdoor monitoring module for monitoring the outdoor Environmental Values and an indoor monitoring module for monitoring the indoor Environmental Values.

5. The programming control system for adjusting an air conditioning equipment of claim 1, wherein the preset indoor Environmental Values comprise target values and/or target difference values from the outdoor Environmental Values.

6. A programming control system for adjusting an air conditioning equipment, comprising:
a database;
a setting module for setting programming information, preset indoor Environmental Values, and preset control parameters corresponding to the preset indoor Environmental Values, and for transmitting the programming information, present indoor Environmental Values, and preset control parameters set by the setting module to the database for saving;
a monitoring unit for monitoring outdoor Environmental Values and/or indoor Environmental Values, and for the monitored outdoor Environmental Values and/or the indoor Environmental Values obtained from the database; and
an air conditioning control device for adjusting and controlling the air conditioning equipment the according to the programming information, the outdoor Environmental Values, the indoor Environmental Values, the preset indoor Environmental Values, and/or the preset control parameters corresponding to the preset indoor Environmental Values; and
an air conditioning control device for adjusting and controlling the air conditioning equipment the according to the programming information, the outdoor Environmental Values, the indoor Environmental Values, the preset indoor Environmental Values, and/or the preset control parameters corresponding to the preset indoor Environmental Values; and
a time counting module for receiving the programming information, preset indoor Environmental Values, and preset control parameters set by the setting module and for executing time count so as to provide the air conditioning control device with time obtained from the execution of time count to thereby enable the air conditioning control device to adjust and control the air conditioning equipment according to the time, the programming information, the outdoor Environmental Values, the indoor Environmental Values, the preset indoor Environmental Values, and/or the preset control parameters.

7. The programming control system for adjusting an air conditioning equipment of claim 6, wherein the database, the setting module, the monitoring unit, the air conditioning control device, and/or the time counting module are connected to a data processing device.

8. The programming control system for adjusting an air conditioning equipment of claim 7, wherein the data processing device is configured for network connection and data transmission, and is capable of connecting with a remote end air conditioning equipment via a network communication system so as to execute adjustment of the remote end air conditioning equipment via the network communication system.

9. The programming control system for adjusting an air conditioning equipment of claim 7, wherein the time is divided into various time periods, and each time period has its corresponding preset indoor Environmental Values.

10. The programming control system for adjusting an air conditioning equipment of claim 6, wherein the monitoring module further comprises an outdoor monitoring unit for monitoring the outdoor Environmental Values and an indoor monitoring module for monitoring the indoor Environmental Values.

11. The programming control system for adjusting an air conditioning equipment of claim 6, wherein the preset indoor Environmental Values comprise target values and/or target difference values from the outdoor Environmental Values.

12. The programming control system for adjusting an air conditioning equipment of claim 6, further comprising a date counting module for receiving the programming information, preset indoor Environmental Values, and preset control parameters set by the setting module and for executing time count so as to provide the air conditioning control device with time obtained from the execution of time count to thereby enable the air conditioning control device to adjust and control the air conditioning equipment according to the time, the programming information, the outdoor Environmental Values, the indoor Environmental Values, the preset indoor Environmental Values, and/or the preset control parameters corresponding to the preset indoor Environmental Values

13. The programming control system for adjusting an air conditioning equipment of claim 10, wherein the date is divided into various date blocks, each date block has its corresponding preset indoor Environmental Values.

14. The programming control system for adjusting an air conditioning equipment of claim 10, wherein the date counting module is connected to a data processing device.

15. The programming control system for adjusting an air conditioning equipment of claim 13, wherein the preset indoor Environmental Values corresponding to the date blocks are different from one another.
